(19) United States
(12) Patent Application Publication
(10) Pub. No.: US 2015/0342128 A1
(43) Pub. Date: Dec. 3, 2015

(54) PLANTING CONTAINER STRUCTURE

(71) Applicant: Chein Tsung OU, Pingtung County (TW)

(72) Inventor: Chien Tsung OU, Pingtung County (TW)

(21) Appl. No.: 14/655,603

(22) PCT Filed: Dec. 27, 2013
(86) PCT No.: PCT/IB2013/061357

§ 371 Date: Jun. 25, 2015

(30) Foreign Application Priority Data
Dec. 28, 2012 (TW) 101225518

(51) Int. Cl. A01G 9/02

(52) U.S. Cl. CPC A01G 9/02

(57) ABSTRACT

The present invention discloses a planting container structure including a planting container containing culture soil for cultivating plants, and a solid fertilizer container containing a solid bone-based fertilizer and inserted in the culture soil. The solid fertilizer container comprises a body part and a tapered part jointed together. The tapered part has a hole, through which the solid bone-based fertilizer seeps into the culture soil to provide base manure for the plants. The solid bone-based fertilizer substantially seeps into the culture soil so as to prolong its usage time. Therefore, the present invention provides a suitable solution for encouraging the eco-environmental treatment of the dead pet through a tree-burial.

### BACKGROUND OF THE INVENTION

1. Field of the Invention

The present invention generally relates to a planting container structure, and more specifically to a planting container structure having a solid fertilizer container containing a solid bone-based fertilizer and provided on a support framework to construct a vertical green wall.

2. The Prior Arts

For most people who live in modern cities, it is difficult to possess a wide land to cultivate a lot of green plants. Instead, growing plants in pots becomes the most popular solution. The pots are placed on the attic, balcony or outdoor to receive sufficient sunlight.

For years, the cult of breeding various pets has becomes much more popular, and the eco-environmental tree-burial treatment of the dead pets has been widely accepted by the environmentalists and the pet owners. In the prior arts, the body of the dead pet is incinerated to ashes, and then the ashes are poured into sea, river, outdoor soil or plant pot. In particular, it is preferred to spread the ashes into the indoor plant pot. However, the ashes commonly contain a phosphate-rich and/or nitrogenous-rich fertilizer, and if the ashes are directly poured into the soil contained in the plant pot, it is possible to cause the plants to grow too fast or encounter growth retardation.

Therefore, it needs a planting container structure with a simpler design and easy operation to provide environmental protection by accommodating the bones or the ashes of the dead pet slowly seeping into the soil, thereby solving the issues in the prior arts.

### SUMMARY OF THE INVENTION

The primary objective of the present invention is to provide a planting container structure, comprising a planting container for containing culture soil for plants, and at least one solid fertilizer container inserted in the culture soil. Specifically, the solid fertilizer container comprises a body part and a tapered part jointed to the body part. The tapered part has at least one hole at a tip or on a side wall such that the solid bone-based fertilizer contained in the solid fertilizer container seeps into the culture soil through the hole, thereby providing base manure for the plants.

The solid fertilizer container further comprises a top cover used to cover and seal an opening of the body part in an attachable manner in order to isolate and protect the solid bone-based fertilizer. The solid bone-based fertilizer substantially slowly seeps into the culture soil so as to prolong its usage time. The present invention thus provides a suitable solution for encouraging the eco-environmental treatment of the dead pet through a tree-burial.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a view showing a planting container structure according to the present invention; and

FIG. 2 is an illustrative application of the planting container structure according to the present invention.

### DETAILED DESCRIPTION OF THE PREFERRED EMBODIMENT

The accompanying drawings are included to provide a further understanding of the invention, and are incorporated in and constitute a part of this specification. The drawings illustrate embodiments of the invention and, together with the description, serve to explain the principles of the invention.

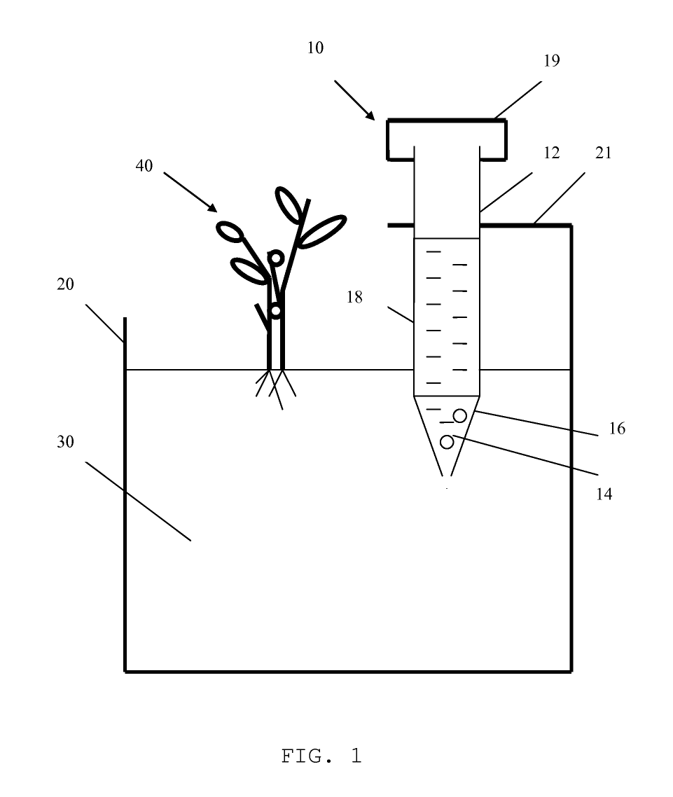

Please refer to FIG. 1 illustrating the planting container structure according to the present invention. As shown in FIG. 1, the planting container structure according to the present invention generally comprises at least one solid fertilizer container 10 and a planting container 20. The planting container 20 is configured to accommodate culture soil 30, and the solid fertilizer container 10 is inserted in the culture soil 30 such that the culture soil 30 is used to cultivate various plants 40 like pot plants, flowers, vegetables and fruit trees.

It should be noted that only one solid fertilizer container 10 is illustrated in FIG. 1 as an example so as to clearly describe the aspects of the present invention, but it is not intended to limit the scope of the present invention. In other words, more than one solid fertilizer container 10 can be inserted into the solid fertilizer container 10.

Specifically, the solid fertilizer container 10 comprises a body part 12 and a tapered part 14 jointed to the body part 12. The tapered part 14 has at least one hole 16 provided at the tip or on the side wall of the tapered part 14. The solid fertilizer container 10 is configured to accommodate the solid bone-based fertilizer 18, which slowly seeps into the culture soil 30 through the at least one hole 16. In addition, the body part 12 is made of a circular tube, and the tapered part 14 has a conical shape.

Preferably, the solid bone-based fertilizer 18 contained in the solid fertilizer container 10 may comprise bones of a dead pet, bone ashes after cremation of the dead pet, or bone powder. The above solid bone-based fertilizer 18 is substantially a phosphate and/or nitrogenous rich base manure, which is essential for the plants to grow. Since the solid bone-based fertilizer 18 is slowly released through the hole 16 of the tapered part 14, the fertilizing effect for the plants can sustain for a long period of time. Therefore, the present invention provides a suitable solution for encouraging the eco-environmental treatment of the dead pet through a tree-burial. Additionally, the solid bone-based fertilizer 18 may further comprise bone powder available in the traditional market.

Furthermore, the solid fertilizer container 10 of the present invention may comprise a top cover 19, which is provided on the body part 12 to cover and seal the opening of the body part 12 through a detachable manner like screw fixing or tight pressing, so as to isolate and protect the solid bone-based fertilizer 18.

To easily fix the solid fertilizer container 10, the planting container 20 comprises at least one fixing part 21, which extends from an outer edge of the planting container 20, and each fixing part 21 has a hole provided for the solid fertilizer container 10 to insert. It is preferred that the solid fertilizer container 10 is vertically inserted into and fixed in the culture soil 30. It should be noted that only one fixing part 21 is shown in FIG. 1 as an illustrative example, and the planting container 20 of the present invention can be provided with more than one fixing part 21.

To drain additional water and avoid too much water stored in the planting container 20, the bottom of the planting container 20 further comprises a plurality of through holes (not shown) and is provided with a base plate (not shown) to accommodate water drained from the through holes.

The above body part 12, the tapered part 14 and the top cover 19 of the solid fertilizer container 10 are made of ceramic, metallic or plastic material, and the planting container 20 is made of ceramic, metallic, plastic or non-woven cloth material.

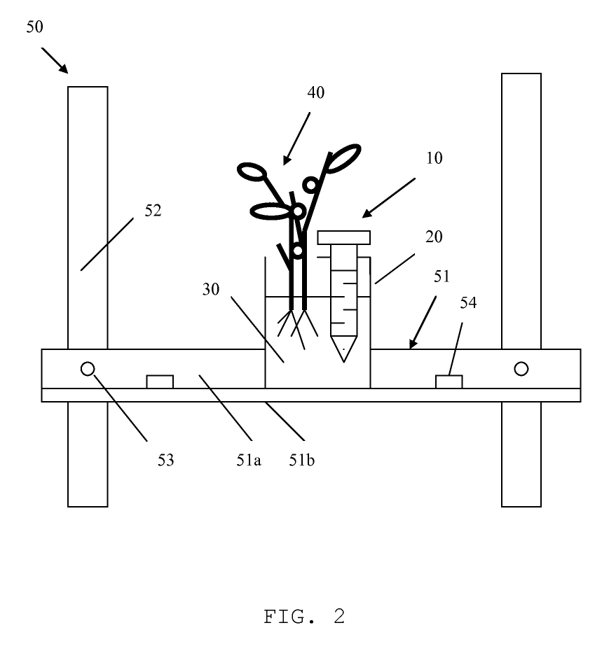

Further refer to FIG. 2 showing an illustrative application of the planting container structure according to the present invention. As shown in FIG. 2, the solid fertilizer container 10 of the present invention is provided on a support framework 50 for cultivating the plants 40, and the support framework 50 is composed of a plurality of plane pieces 51 and a plurality of vertical rods 52. The plane pieces 51 are horizontally configured, and the vertical rods 52 are vertically configured. Each plane piece 51 is fixed to the respective vertical rods 52 by at least one first screw 53 so as to support the solid fertilizer container 10. Specifically, the plane piece 51 comprises a horizontal rod 51a and a support plate 51b, and the horizontal rod 51a is fixed to the support plate 51b by at least one second screw 54.

Preferably, the horizontal rod 51a and the support plate 51b of the plane piece 51 are made of ion or steel material, wherein the ion material include an angle iron bar or a zinc plated angle iron bar, and the steel material includes an angle steel bar or a zinc plated angle steel bar.

From the above-mentioned, one aspect of the present invention is that the solid bone-based fertilizer is contained in the solid fertilizer container, which is inserted in the culture soil, so as to conveniently provide base manure for the plants. Especially, the solid bone-based fertilizer slowly seeps into the soil, resulting in a longer usage time. The frequency of replenishing the fertilizer is lowered and the demand of the manpower is also reduced. In particular, the present invention provides a suitable solution for encouraging the eco-environmental treatment of the dead pet through a tree-burial.

Although the present invention has been described with reference to the preferred embodiments thereof, it is apparent to those skilled in the art that a variety of modifications and changes may be made without departing from the scope of the present invention which is intended to be defined by the appended claims.

1. A planting container structure provided on a support framework for cultivating plants, comprising:
a planting container for containing culture soil; and
at least one solid fertilizer container containing a solid bone-based fertilizer and inserted in the culture soil, the solid fertilizer container comprising a body part and a tapered part jointed to the body part, the tapered part having at least one hole at a tip or on a side wall,
wherein the solid bone-based fertilizer is provided as base manure for the plants and seeps into the culture soil through the at least one hole, the support framework is composed of a plurality of plane pieces and a plurality of vertical rods, the vertical rods are vertically configured, the plane pieces are horizontally configured, and each plane piece is fixed to the respective vertical rods by at least one first screw to support the solid fertilizer container.

2. The planting container structure as claimed in claim 1, wherein the solid fertilizer container further comprises a top cover used to cover and seal an opening of the body part in a detachable manner so as to isolate and protect the solid bone-based fertilizer.

3. The planting container structure as claimed in claim 2, wherein the detachable manner comprises screw fixing or tight pressing.

4. The planting container structure as claimed in claim 1, wherein the solid bone-based fertilizer comprises bones of a dead pet, bone ashes after cremation of the dead pet, or bone powder.

5. The planting container structure as claimed in claim 1, wherein the plane piece comprises a horizontal rod and a support plate, and the horizontal rod is fixed to the support plate by at least one second screw.

6. The planting container structure as claimed in claim 1, wherein the planting container further comprises at least one fixing part extending from an outer edge of the planting container, and each fixing part has a hole provided for the solid fertilizer container to insert.
